(19) United States
(12) Patent Application Publication
(10) Pub. No.: US 2002/0137531 A1
(43) Pub. Date: Sep. 26, 2002

(54) Process for operating a radio-based communications system

(75) Inventor: Michael Jeschke, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/101,953

(22) Filed: Mar. 21, 2002

(30) Foreign Application Priority Data
Mar. 23, 2001 (EP) 01 440 084.0

(51) Int. Cl. H04Q 7/20

(52) U.S. Cl. 455/466; 455/414; 455/566

(57) ABSTRACT

A method is described for operating a radio-based communications system. An item of advertising information is sent from a base station (BS) to at least one mobile station (MS). The mobile station (MS) checks whether an action is being carried out by a user of the mobile station (MS) in the course of which a display panel (AF) of the mobile station (MS) is being viewed by the user. To the extent that this is the case, the received advertising information is displayed on the display panel (AF) of the mobile station MS). The mobile station (MS) sends back a confirmation relating to the display of the advertising information to the base station (BS).

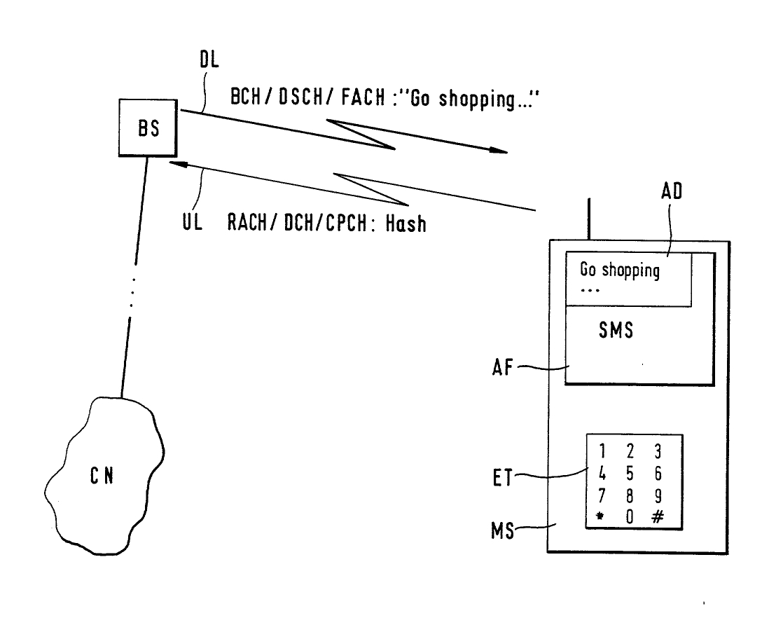

### BACKGROUND OF THE INVENTION

The invention is related to a method for operating a radio-based communications system wherein an item of optical advertising information is sent from a base station to at least one mobile station, whereby a check is made as to whether an action is being carried out by a user of the mobile station and whereby—to the extent that this is the case—the user is informed of the received advertising information on the mobile station, and whereby a confirmation relating to the advertising information is sent back from the mobile station to the base station, wherein a check is made by the mobile station continually or at least at successive time-intervals as to whether an action relating to the mobile station is being carried out by a user of the mobile station in the course of which a display panel of the mobile station is being viewed by the user, and in that—to the extent that this is the case—the received advertising information is displayed in a predetermined region AD of the display panel of the mobile station, and in that the confirmation relating to the display of the advertising information is sent back from the mobile station to the base station via a channel that is assigned only to the mobile station. The invention relates furthermore to a corresponding radio-based communications system and a corresponding mobile station for said system.

The invention is based on a priority application EP 01 440 084.0 which is hereby incorporated by reference.

From U.S. Pat. No. 5,870,030 a method is known wherein, within a mobile communications system, an item of optical advertising information (called “advertisement” therein or also “ad” for short) is sent from a base station to at least one mobile station (described in the patent in the form of a “one-way pager” or “two-way pager”). The advertising information is intended to be represented on the display panel of the mobile station and to be read by the user by way of compensation for the use of toll-free services (see, for instance, the Abstract of said patent). The advertising information is represented on the display panel whenever the user has output a manual request for it beforehand (see the patent, column 8, lines 21 ff: “After receiving a manual request from the user, the pager presents a message, such as an ad. The user views the ad on a display . . . ”). Accordingly, a check is made as to whether the user has carried out an action (“manual request”). If this is the case, the advertising information is displayed. Hence it is ensured that the user sees the advertising information only when he desires it. Finally, the user is also invited to answer questions. Hence the system receives a confirmation of the fact that the user has taken note of the advertising information. In turn, the user is given a bonus in his charge account (see the patent, column 8, lines 50 ff: “The benefits of answering the questions . . . to automatically add credit to the paging service account. The user answers the questions using conventional user input means, such as push buttons, . . . ”). As described further in the patent, in column 8, line 63 to column 9, line 3, confirmation in the case of a one-way pager can only be effected over the fixed telephone network. In addition, here—both in the case of a one-way pager and in the case of a two-way pager—the answers have to be examined with regard to their correctness (“the system controller determines whether the answers are correct . . . ”), which once again represents a great technical effort.

From EP-A-1 003 344 (see Abstract and column 2, lines 37-50) a method is known wherein so-called “sponsored calls” —that is to say, subsidised mobile-telephone calls—can be implemented. For this purpose, both acoustic and optical advertising information (“recorded advertisements” and “text messages”) are sent to the users of the mobile stations (see also column 7, lines 36-44). The combination of the acoustic message-form with the optical message-form serves to ensure that the user actually takes note of the advertising information with a higher probability and remembers it better (see column 3, lines 1-15). In addition, supplementary information can also easily be added to the text message (see column 3, lines 46-52). Here too, the receipt of the advertising information is confirmed, but only on request which has to be acknowledged with an identifier which the system generates in the form of a random number (see column 7, lines 47-56): “. . . a randomly generated acknowledgement code announcement . . . ”). This method is also quite elaborate and requires the input of the code by the user.

Moreover, from U.S. Pat. No. 6,088,343 (column 10, lines 52 to 57) it is known, in the case of a GSM communications system, to broadcast advertising information via a so-called broadcast channel to a plurality of mobile stations within a cell of the communications system. However, further details with respect to the broadcasting, display and, optionally, reimbursement of this advertising information are not described in this patent.

### SUMMARY OF THE INVENTION

The object of the invention is to create a method of the type specified in the introduction wherein not only advertising information can be caused to be displayed on a mobile station and wherein not only the displayed advertising information can also be reimbursed in some way but wherein a check is also made as to whether the user is actually able to take note of the advertising information.

This object is achieved by virtue of a method for operating a radio-based communications system wherein an item of optical advertising information is sent from a base station to at least one mobile station, whereby a check is made as to whether an action is being carried out by a user of the mobile station and whereby—to the extent that this is the case—the user is informed of the received advertising information on the mobile station, and whereby a confirmation relating to the advertising information is sent back from the mobile station to the base station, wherein a check is made by the mobile station continually or at least at successive time-intervals as to whether an action relating to the mobile station is being carried out by a user of the mobile station in the course of which a display panel of the mobile station is being viewed by the user, and in that—to the extent that this is the case—the received advertising information is displayed in a predetermined region AD of the display panel of the mobile station, and in that the confirmation relating to the display of the advertising information is sent back from the mobile station to the base station via a channel that is assigned only to the mobile station . The object is also achieved by virtue of a mobile station for a radio-based communications system wherein an item of optical advertising information is sent from a base station to the mobile station, wherein a check is made as to whether an action is being carried out by a user of the mobile station, and—to the extent that this is the case—the user is informed of the received advertising information on the mobile station, whereby the mobile station sends back a confirmation relating to the advertising information to the base station, wherein the mobile station checks continually or at least at successive time-intervals whether an action relating to the mobile station is being carried out by a user of the mobile station in the course of which a display panel of the mobile station is being viewed by the user, in that—to the extent that this is the case—the received advertising information is displayed in a predetermined region AD of the display panel of the mobile station, and in that the mobile station sends back a confirmation relating to the display of the advertising information to the base station via a channel that is assigned only to the mobile station and by virtue of a communications system wherein an item of optical advertising information is sent from a base station to at least one mobile station, wherein a check is made as to whether an action is being carried out by a user of the mobile station, wherein—to the extent that this is the case—the user is informed of the received advertising information on the mobile station, and wherein the mobile station sends back a confirmation relating to the advertising information to the base station, wherein the mobile station checks continually or at least at successive time-intervals whether an action relating to the mobile station is being carried out by a user of the mobile station in the course of which a display panel of the mobile station is being viewed by the user, in that—to the extent that this is the case—the received advertising information is displayed in a predetermined region AD of the display panel of the mobile station, and in that the mobile station sends back a confirmation relating to the display of the advertising information to the base station via a channel that is assigned only to the mobile station.

According to the invention, the advertising information is displayed precisely when the user is actually in a position to take note of the advertising information on the mobile station. If this is the case, then for the purpose of ascertaining the reimbursement a confirmation relating to the noting of the advertising information is sent back from the mobile station. The base station or some other institution, for example an appropriate server or such like, can then infer from the confirmations received the period of time during which the advertising information has been displayed on the mobile station and which accordingly has to be reimbursed or offset. Hence the essential advantage is obtained that only that period of time is taken into account when ascertaining the reimbursement during which it was actually possible for the user to take note of the advertising information. Overall this enables a meaningful broadcasting, display and reimbursement or offset of advertising information within the communications system.

In an advantageous further development of the invention the advertising information is sent simultaneously to a plurality of mobile stations. In particular, the advertising information is broadcast to all mobile stations that are located in the local area covered by the associated base station. This entails the significant advantage that the advertising information can be sent to the mobile stations via a channel that is assigned to all the mobile stations. In this connection it may be a question, in particular, of a so-called broadcast channel.

In contrast to this, in another advantageous configuration of the invention the confirmation relating to the display of the advertising information is sent to the base station via a channel that is assigned to only one of the mobile stations. Hence it is guaranteed that, via the confirmations that have been sent back, for each individual mobile station exactly that period of time can be ascertained during which the advertising information has been displayed on this mobile station. Hence it is possible to reimburse each mobile station individually.

In a particularly advantageous further development of the invention the mobile station generates a hash code as a function of the displayed advertising information and broadcasts said hash code to the base station by way of confirmation. The hash code has the advantage that, on the one hand, it can be created without great effort but that, on the other hand, it is nevertheless extremely tamper-proof. Moreover, the use of the hash code has the advantage that no numbers or such like have to be assigned to the individual items of advertising information which then have to be broadcast to the mobile stations in addition together with the advertising information.

### BRIEF DESCRIPTION OF THE DRAWINGS

Further features, possible applications and advantages of the invention will become apparent from the following description of exemplary embodiments of the invention which are represented in the drawing. In this connection all the features that are described or represented constitute—by themselves or in arbitrary combination—the subject-matter of the invention, irrespective of their summary in the Claims or the subordinating references therein and also irrespective of their formulation and representation in the description and in the drawing, respectively.

The single FIGURE of the drawing shows a schematic block diagram of an exemplary embodiment of a method according to the invention for operating a radio-based communications system.

In the Figure a network CN (CN=core network) is represented which may be a UMTS network (UMTS=universal mobile telecommunication system), for example. The network CN is coupled to a base station BS which covers a certain local area which may comprise a plurality of so-called cells. Moreover, a mobile station (MS=mobile station) which is located in this local area is represented in the FIGURE. The mobile station MS comprises an input keyboard ET for certain characters as well as a display panel AF, for example for the display of so-called SMS messages (SMS=short message service).

The base station BS and the mobile station MS can exchange data with one another in both directions by radio. This is indicated in the FIGURE by the two arrows DL (DL=downlink) and UL (UL=uplink).

For the transmission of data from the base station BS to the mobile station MS—that is to say, in the downlink DL—it is possible via a so-called broadcast channel BCH (BCH=broadcast channel) to transmit the data simultaneously to all the mobile stations MS that are currently located in a cell assigned to the broadcast channel BCH. A similar transmission of data to all the mobile stations MS that are present in the area of the base station BS is also possible via a so-called common channel DSCH (DSCH=downlink shared channel) or via a so-called forward channel FACH (FACH=forward access channel).

Via one or more of these channels—that is to say, via the BCH and/or the DSCH and/or the FACH—an item of advertising information is transmitted from the base station BS to all the mobile stations MS in the associated local area. The advertising information may be present in optical form and/or in acoustic form. In this connection the advertising information is configured in such a way that it can be displayed or played back, respectively, on the display panel AF or via a loudspeaker, of a handsfree device for example, of the mobile station MS. In all the mobile stations MS the advertising information is either processed immediately or is stored temporarily in order to be processed afterwards. In the Figure, at the arrow for the downlink DL, the text “Go shopping . . . ” is indicated in exemplary manner by way of optical advertising information. This optical advertising information will be drawn upon in the following for more detailed elucidation of the present exemplary embodiment. It goes without saying that an item of acoustic advertising information could be drawn upon in corresponding manner.

The processing of the aforementioned advertising information will be elucidated in the following on the basis of the mobile station MS represented in the FIGURE. It goes without saying that this type of processing can also be carried out optionally by other or all mobile stations MS within the local area of the base station BS.

The mobile station MS checks continually or at least at successive times whether the user of the mobile station MS is executing an action in the course of which it is necessary that he is viewing the display panel AF of the mobile station MS at this moment. An action of such a type may be, for example, the writing of an SMS message by means of the input keyboard ET, or surfing the Internet, or the retrieval of data from the Internet or such like. In the case of an action of such a type it may also be a question of the user playing a computer game on the mobile station MS or making entries in a telephone directory or address book or such like.

If an action of such a type on the part of the user is recognised by the mobile station MS, the mobile station MS now causes the last-received and optionally buffered advertising information to be displayed on the display panel AF of the mobile station MS. This can be effected, for example, by the advertising information being displayed in a predetermined region AD of the display panel AF, specifically in such a way that the action which has been carried out as such by the user of the mobile station MS—that is to say, the writing of an SMS message, for example—does not have the advertising information superimposed on it and is therefore not interfered with.

The advertising information is then caused to be displayed on the display panel AF of the mobile station MS for such time until the mobile station MS recognises that the user is no longer carrying out an action in the course of which he is viewing the display panel AF.

During the period of time in which the advertising information is displayed on the display panel AF of the mobile station MS the mobile station MS continuously sends confirmations to the base station BS via the uplink UL, from each of which it is evident that the advertising information is being displayed on the display panel AF of the mobile station MS. Alternatively it is possible for the confirmation to be sent once only to the base station BS at the end of the display of the advertising information. In this case the length of time for which the advertising information has been displayed can be ascertained by a certain display-time per overlay of the advertising information being permanently predetermined in advance.

These confirmations can be used by a server in the network CN or in some other institution which is present there for the purpose of reimbursing the display of the advertising information, for example to the user of the mobile station MS in time-dependent manner or per overlay or for the purpose of offsetting it in some other way.

The aforementioned confirmations can, for example, be effected via a so-called RACH (RACH=random access channel) and/or a so-called DCH (DCH=dedicated channel) and/or a so-called CPCH (CPCH=common packet channel) in the uplink UL and hence can be transmitted from the mobile station MS to the base station BS. In this connection the selection of the particular channel depends on the condition in which the mobile station MS is found at the particular moment, for example on whether the mobile station MS is in no-load operation or not.

By way of confirmation relating to the display of the advertising information on the mobile station MS, use may be made, for example, of a number that is assigned to each item of advertising information and that is sent from the base station BS to the mobile station MS together with the advertising information. As soon as the advertising information is displayed on the display panel AF of the mobile station MS, the mobile station MS sends this number back again by way of confirmation of the display of the advertising information. This is repeated continuously or for each overlay as long as the advertising information is being displayed on the mobile station. On the basis of the number of numbers sent back successively the network CN is then able to recognise how long the advertising information or how many overlays has been caused to be displayed on the mobile station.

Likewise it is possible to make use of a so-called hash code by way of confirmation. This hash code is generated from the advertising information itself with the aid of a predetermined algorithm. An algorithm of such a type is described in IETF RFC 1321 (Internet Engineering Task Force, Request for Comments), for example. The hash code can consequently be generated by the network CN and by the mobile station MS independently of one another and therefore does not have to be transmitted together with the advertising information. As soon as an item of advertising information is caused to be displayed on the mobile station MS, the mobile station MS confirms this by the associated hash code being sent back. The network CN generates the corresponding hash code independently of the mobile station MS on the basis of the advertising information that has been sent out and compares said hash code with the hash code received by the mobile station MS. The network CN infers from an agreement the display of the advertising information on the mobile station MS and takes this into account in the form of a reimbursement or such like. In this connection the number of hash codes received back at the network CN is in turn representative of the period of time for which the advertising information has been displayed on the mobile station. If only one confirmation is broadcast per overlay of an item of advertising information, in this case the hash code may also additionally contain the duration of the overlay.

The advertising information can be broadcast again at predetermined time-intervals. As a result of the intermediate storage of the advertising information in the mobile station MS, said advertising information can also be caused to be displayed within the time-ranges in between. Moreover, the advertising information can also be changed or exchanged at other predetermined time-intervals. Likewise, by reason of the emission of the advertising information to all mobile stations MS of a certain local area of a base station BS it is possible to configure the advertising information in location-specific manner.

With the aid of the confirmations that have been sent back to the network CN the network CN is able to recognise how long or how often an item of advertising information has been caused to be displayed on a certain mobile station MS. Depending on this period of time or this number, the network CN can then bestow a monetary reimbursement on the user of the mobile station MS, for example in the form of a reduction in the telephone charges. Alternatively, or in addition, it is possible for the network CN to charge appropriate advertising costs to the sponsor of the advertising information, depending on these display periods or numbers.

1. A method for operating a radio-based communications system wherein an item of optical advertising information is sent from a base station to at least one mobile station, whereby a check is made as to whether an action is being carried out by a user of the mobile station and whereby—to the extent that this is the case—the user is informed of the received advertising information on the mobile station, and whereby a confirmation relating to the advertising information is sent back from the mobile station to the base station, wherein a check is made by the mobile station continually or at least at successive time-intervals as to whether an action relating to the mobile station is being carried out by a user of the mobile station in the course of which a display panel of the mobile station is being viewed by the user, and in that—to the extent that this is the case—the received advertising information is displayed in a predetermined region AD of the display panel of the mobile station, and in that the confirmation relating to the display of the advertising information is sent back from the mobile station to the base station via a channel that is assigned only to the mobile station.

2. Method according to claim 1, wherein the advertising information is sent simultaneously to a plurality of mobile stations via a channel that is assigned to all the mobile stations.

3. Method according to one of claims 1 to 2, wherein the confirmation is sent to the base station once per overlay of the advertising information.

4. Method according to claim 3, wherein the confirmation receives the duration of the overlay.

5. Method according to one of claims 1 to 4, wherein the confirmation is sent to the base station repeatedly at predetermined time-intervals as long as an action relating to the mobile station is being carried out by the user of the mobile station.

6. Method according to one of claims 1 to 5, wherein a hash code is generated by the mobile station as a function of the displayed advertising information and is broadcast to the base station by way of confirmation.

7. A mobile station for a radio-based communications system wherein an item of optical advertising information is sent from a base station to the mobile station, wherein a check is made as to whether an action is being carried out by a user of the mobile station, and—to the extent that this is the case—the user is informed of the received advertising information on the mobile station, whereby the mobile station sends back a confirmation relating to the advertising information to the base station,
wherein the mobile station checks continually or at least at successive time-intervals whether an action relating to the mobile station is being carried out by a user of the mobile station in the course of which a display panel of the mobile station is being viewed by the user, in that—to the extent that this is the case—the received advertising information is displayed in a predetermined region AD of the display panel of the mobile station, and in that the mobile station sends back a confirmation relating to the display of the advertising information to the base station via a channel that is assigned only to the mobile station.

8. Mobile station according to claim 7, wherein means are provided that are suitable for generating a hash code as a function of the displayed advertising information and for broadcasting said hash code to the base station by way of confirmation.

9. Mobile station according to claim 7, wherein the advertising information is caused to be displayed on the display panel of the mobile station for such time until the mobile station recognises that the user is no longer carrying out an action in the course of which he is viewing the display panel.

10. A radio-based communications system wherein an item of optical advertising information is sent from a base station to at least one mobile station, wherein a check is made as to whether an action is being carried out by a user of the mobile station, wherein—to the extent that this is the case—the user is informed of the received advertising information on the mobile station, and wherein the mobile station sends back a confirmation relating to the advertising information to the base station,
wherein the mobile station checks continually or at least at successive time-intervals whether an action relating to the mobile station is being carried out by a user of the mobile station in the course of which a display panel of the mobile station is being viewed by the user, in that—to the extent that this is the case—the received advertising information is displayed in a predetermined region AD of the display panel of the mobile station, and in that the mobile station sends back a confirmation relating to the display of the advertising information to the base station via a channel that is assigned only to the mobile station.
